(19) United States
(12) Patent Application Publication
(10) Pub. No.: US 2008/0152389 A1
(43) Pub. Date: Jun. 26, 2008

(54) ELECTROPHOTOGRAPHIC IMAGE FORMING APPARATUS HAVING TRANSPARENT TONER

(75) Inventor: Young-min KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/779,993

(22) Filed: Jul. 19, 2007

(30) Foreign Application Priority Data
Dec. 26, 2006 (KR) 2006-134155

(51) Int. Cl. G03G 15/01

(52) U.S. Cl. 399/223; 399/298; 399/299

(57) ABSTRACT

An electrophotographic image forming apparatus that includes a photosensitive body, an exposing unit to form an electrostatic latent image on the photosensitive body charged to a uniform electric potential, a first developing unit to develop the electrostatic latent image on the photosensitive body by supplying a transparent toner thereto, a transparent toner container in which the transparent toner to be supplied to the first developing unit is accommodated, and a second developing unit to develop the electrostatic latent image on the photosensitive body by supplying color toners thereto and having a toner-accommodating unit in which the color toners are accommodated.

### CROSS-REFERENCE TO RELATED APPLICATIONS

This application claims the benefit of Korean Patent Application No. 10-2006-0134155, filed on Dec. 26, 2006, in the Korean Intellectual Property Office, the disclosure of which incorporated herein in its entirety by reference.

### BACKGROUND OF THE INVENTION

1. Field of the Invention

The present general inventive concept relates to an image forming apparatus, and more particularly, to an electrophotographic image forming apparatus having a transparent toner.

2. Description of the Related Art

Electrophotographic image forming apparatuses form an electrostatic latent image by scanning light onto a photosensitive body charged to a uniform electric potential, develop the electrostatic latent image with a predetermined color of toner and then transfer and fuse the developed image to and on a printing medium, thereby printing a desired image. In general, four colors of toners, such as yellow (Y), magenta (M), cyan (C), and black (B), are used in electrophotographic color image forming apparatuses, and four developing units are used to develop the electrostatic latent image formed on the photosensitive body with these four colors of toners.

A toner is manufactured based on a plastic resin, and thus has some gloss. A portion of a printed image to which the toner is attached has some gloss, but a background region of the printed image to which the toner is not attached has no gloss. In addition, the higher coverage (the ratio of an area to which the toner is attached to the area of the printing medium) of the printed image, the higher the gloss. The gloss of the printed image affects the visual quality of the image. U.S. Patent Publication No. 2006/0127134 discloses an image forming apparatus featuring a transparent image forming station to improve the gloss of a printed image by employing developing devices for developing electrostatic images with color toners and a developing device for developing an electrostatic image with a transparent toner. In such an image forming apparatus, the amount of a consumed transparent toner is considerably larger than the amount of a consumed color toner.

### SUMMARY OF THE INVENTION

The present general inventive concept provides an electrophotographic image forming apparatus having an improved structure in which a transparent toner having a large consumed amount can be smoothly supplied.

The present general inventive concept also provides an electrophotographic image forming apparatus in which a period for replacing a developing unit for a transparent toner and a period for replacing a developing unit for a color toner coincide with each other.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic image forming apparatus including: a photosensitive body; an exposing unit forming an electrostatic latent image on the photosensitive body charged to a uniform electric potential; a first developing unit to develop the electrostatic latent image on the photosensitive body by supplying a transparent toner thereto; a transparent toner container in which the transparent toner to be supplied to the first developing unit is accommodated; and a second developing unit to develop the electrostatic latent image on the photosensitive body by supplying color toners thereto and having a toner-accommodating unit in which the color toners are accommodated.

Color images may be printed using a multiple pass technique by comprising a plurality of the second developing units to develop the electrostatic latent image on the photosensitive body by supplying different color toners thereto and a transfer medium to which a plurality of color toner images and a transparent toner image sequentially formed on the photosensitive body are sequentially transferred.

The photosensitive body may include a first photosensitive body corresponding to the first developing unit; and a second photosensitive body corresponding to the second developing unit, and wherein the exposing unit includes a first exposing unit corresponding to the first photosensitive body and a second exposing unit corresponding to the second photosensitive body. Color images may be printed using a single pass technique by including a plurality of the second photosensitive bodies, a plurality of the second exposing units to form electrostatic latent images on the plurality of the second photosensitive bodies, and a plurality of the second developing units to develop the electrostatic latent images of the plurality of the second photosensitive bodies by supplying different color toners thereto.

A life span of the transparent toner container may be shorter than life spans of the first and second developing units.

The foregoing and/or other aspects and utilities of the present general inventive concept are also achieved by providing an electrophotographic image forming apparatus including: a photosensitive body; an exposing unit forming an electrostatic latent image on the photosensitive body charged to a uniform electric potential; a first developing unit to develop the electrostatic latent image on the photosensitive body by supplying a transparent toner thereto; a second developing unit to develop the electrostatic latent image on the photosensitive body by supplying color toners thereto; a transparent toner container in which the transparent toner to be supplied to the first developing unit is accommodated; and a color toner container in which the color toners to be supplied to the second developing unit are accommodated, wherein the number of the transparent toner containers is larger than the number of the color toner containers.

The foregoing and/or other aspects and utilities of the present general inventive concept are also achieved by providing an electrophotographic image forming apparatus including: a photosensitive body; an exposing unit to form an electrostatic latent image on the photosensitive body charged to a uniform electric potential; a first developing unit to develop the electrostatic latent image on the photosensitive body by supplying a transparent toner thereto; a second developing unit to develop the electrostatic latent image on the photosensitive body by supplying color toners thereto; a transparent toner container in which the transparent toner to be supplied to the first developing unit is accommodated; and a color toner container in which the color toners to be supplied to the second developing unit are accommodated, wherein a capacity of the transparent toner container is larger than a capacity of the color toner container.

Life spans of the transparent toner container and the color toner container may be shorter than life spans of the first and second developing units.

Color images may be printed using a multiple pass technique by including a plurality of the second developing units and a plurality of the color toner containers to develop the electrostatic latent image on the photosensitive body by supplying different color toners thereto and a transfer medium to which a plurality of color toner images and a transparent toner image are sequentially formed on the photosensitive body.

The photosensitive body may include: a first photosensitive body corresponding to the first developing unit; and a second photosensitive body corresponding to the second developing unit, and wherein the exposing unit include: a first exposing unit corresponding to the first photosensitive body; and a second exposing unit corresponding to the second photosensitive body. Color images may be printed using a single pass technique by including a plurality of the second photosensitive bodies, a plurality of the second exposing units to form electrostatic latent images on the plurality of the second photosensitive bodies, a plurality of the second developing units and a plurality of the color toner containers to develop the electrostatic latent images of the plurality of the second photosensitive bodies by supplying different color toners thereto.

The foregoing and/or other aspects and utilities of the present general inventive concept are also achieved by providing an electrophotographic image forming apparatus including a first photosensitive body to carry a transparent toner image using an electrostatic potential, at least one second photosensitive body to carry a respective color image using an electrostatic potential, a first developing unit to accommodate transparent toner and to develop the transparent image onto the first photosensitive body, at least one second developing unit to accommodate a respective color toner and to develop a respective color toner image onto the second photosensitive body, and at least one replaceable transparent toner container to accommodate additional transparent toner and to supply the additional transparent toner to the first developing unit.

Each of the at least one second developing unit may include a toner accommodating unit to accommodate the respective color toner, wherein the toner accommodating capacity of the replaceable transparent toner container is larger than the toner accommodating capacity of the toner accommodating units.

The image forming apparatus may also include at least one replaceable color toner container to accommodate a respective additional color toner and to supply the additional color toner to a toner accommodating unit of the respective at least one second developing unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates the structure of a single pass color image forming apparatus having a replaceable transparent toner container which is a type of an electrophotographic image forming apparatus according to an embodiment of the present general inventive concept;

FIG. 2 illustrates an electric potential of the surface of an exposed photosensitive drum;

FIG. 3 illustrates the structure of an electrophotographic image forming apparatus employing a direct transfer technique according to another embodiment of the present general inventive concept;

FIG. 4 illustrates the structure of a multiple pass color image forming apparatus having a replaceable transparent toner container which is a type of an electrophotographic image forming apparatus according to another embodiment of the present general inventive concept;

FIG. 5 is a perspective view illustrating an example of a structure to connect a first developing unit and a transparent toner container;

FIG. 6 is a side cross-sectional view of FIG. 5;

FIG. 7 illustrates the structure of a multiple pass color image forming apparatus in which two replaceable transparent toner containers are connected to each other, which is a type of an electrophotographic image forming apparatus according to another embodiment of the present general inventive concept; and

FIG. 8 illustrates the structure of a multiple pass color image forming apparatus in which each of two transparent toner containers is connected to a first developing unit, which is a type of an electrophotographic image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

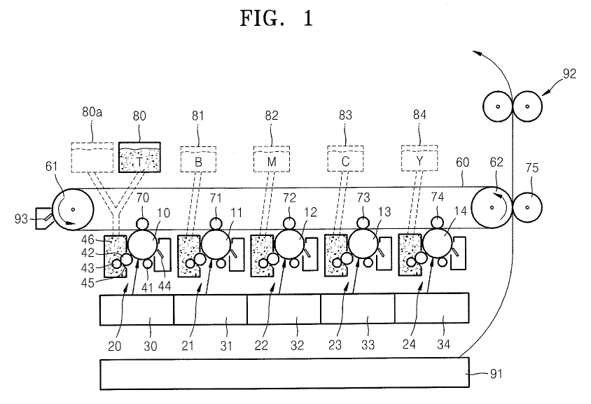

FIG. 1 illustrates the structure of an electrophotographic image forming apparatus according to an embodiment of the present general inventive concept. Referring to FIG. 1, the electrophotographic image forming apparatus according to the present embodiment is a single pass color image forming apparatus which includes a first photosensitive drum 10, a first exposing unit 30, and a first developing unit 20 which are used to develop a transparent toner image, and second photosensitive drums 11, 12, 13, and 14, second exposing units 31, 32, 33, and 34, and second developing units 21, 22, 23, and 24 which are used to develop color toner images. A transparent toner is accommodated in the first developing unit 20. In particular, the transparent toner is supplied to the first developing unit 20 from a replaceable transparent toner-accommodating unit 80. Each of four developing units 21, 22, 23, and 24 comprises a toner-accommodating unit 46 in which each color toner such as black (B), magenta (M), cyan (C), and yellow (Y) is accommodated.

For example, in order to implement a single color image forming apparatus to print a black image, it will be understood by those of ordinary skill in the art that the first photosensitive drum 10, the first exposing unit 30, and the first developing unit 20 which are used to develop a transparent toner image, and the second photosensitive drum 11, the second exposing unit 31, and the second developing unit 21 which are used to develop a black toner image are necessary.

Color toners and a transparent toner according to the present embodiment are mono-component toners. A colorant to cause a change in color of a binder resin, internal additives such as charge control agent (CCA), wax or the like, and external additives such as silica and titanium oxide (TiO₂) are added to the color toners. The composition of the transparent toner is almost the same as the composition of the color toners except for the colorant and the additives for adjusting gloss. The color toners and the transparent toner are charged to a negative (−) or positive (±) polarity. The case where the color toners and the transparent toner are charged to a negative (−) polarity will now be described.

A negative polarity material, such as polyvinyl chloride, chloride vinyl-styrene copolymer, chloride vinyl-acetate vinyl copolymer, chlorination polystyrene, chlorination polyester, chlorination polyethylene, chlorination paraffin, phenol resin, salicylic acid resin, rosin modified maleic resin, rosin modified phenol resin, or alkyl phenol resin may be added to the transparent toner. One type or two or more types of the above-described additives may be used. The granular diameter of the transparent toner is about 5-20 μm and may be 5-10 μm. In addition, other components may be added to the transparent toner if needed. For example, if wax, fatty acid or metallic salt of fatty acid is added to the transparent toner, when the transparent toner is melted by heat during a fusing operation, a uniform layer is easily formed and transparency is improved so that a color image having excellent surface gloss can be obtained. In addition, offset during the fusing operation can also be prevented. Metallic salt of fatty acid may include metallic salt of stearic acid such as stearic acid zinc, stearic acid barium, stearic acid cadmium, and stearic acid magnesium, metallic salt of oleic acid such as oleic acid zinc, oleic acid manganese, oleic acid iron, oleic acid cobalt, oleic acid copper, and oleic acid magnesium, metallic salt of parmitine acid such as parmitine acid zinc, parmitine acid cobalt, parmitine acid copper, parmitine acid magnesium, parmitine acid aluminum, and parmitine acid calcium, metallic salt of capric acid such as capric acid salt, and metallic salt of linoleic acid such as linoleic acid zinc, linoleic acid cobalt, and linoleic acid calcium. Wax may include polystyrene glycol, carnauba wax, paraffin, and chlorination paraffin, and fatty acid may include stearic acid, oleic acid, parmitine acid, capric acid salt, and linoleic acid. One type or two or more types of the wax, the fatty acid or the metallic salt of fatty acid having 0.1-7 wt %, preferably, 0.1-5 wt % may be included in a binder resin of the transparent toner. In addition, in order to improve fluidity of toner, silica, alumina, titanium dioxide or organic resin particle or the like may be added to the transparent toner.

Charging amounts of the color toners and the transparent toner are about −10 to −25 μC/g measured in suction type Faraday Gauge, and a layer of toner on a developing roller 42 is about 0.5 to 1 mg/cm².

The first photosensitive drum 10 and each of the four second photosensitive drums 11, 12, 13, and 14 is an example of a photosensitive body on which an electrostatic latent image is to be formed, for example, an organic photosensitive body or an Amorphous silicon photosensitive body having a long life span. The first photosensitive drum 10 and each of the second photosensitive drums 11, 12, 13, and 14 correspond to the first developing unit 20 and each of the second developing units 21, 22, 23, and 24.

The first exposing unit 30 and each of the second exposing units 31, 32, 33, and 34 scans light modulated according to image information about transparent (T), black (B), magenta (M), cyan (C), and yellow (Y) colors, respectively, onto the first photosensitive drum 10 and the second photosensitive drum 11, 12, 13, and 14, and thereby forms electrostatic latent images. A laser scanning unit (LSU) that uses a laser diode as a light source, is usually used as each of the first and second exposing units 30, 31, 32, 33, and 34.

Each of charging rollers 41 is an example of a charging unit to charge each of the first photosensitive drum 10 and the second photosensitive drums 11, 12, 13, and 14 to a uniform surface electric potential. The charging rollers 41 are in contact with the first and second photosensitive drums 10, 11, 12, 13, and 14, respectively. A charging bias voltage is applied to each of the charging rollers 41.

The first developing unit 20 and each of the second developing units 21, 22, 23, and 24 comprises a developing roller 42 and a supply roller 43. The supply roller 43 is rotated in contact with the developing roller 42 and attaches the toner accommodated in each of the first and second developing units 20, 21, 22, 23, and 24 to the developing roller 42 by friction charge. The first and second developing units 20, 21, 22, 23, and 24 may further comprise a regulating unit 45 which regulates the amount of the toner attached to the surface of the developing roller 42 to form a layer of toner having a uniform thickness. For example, the regulating unit 45 may be an elastic plate or roller which is elastically in contact with the developing roller 42. In addition, the first and second developing units 20, 21, 22, 23, and 24 may further comprise at least one carrying unit (not illustrated) which carries the toner accommodated in each of the first and second developing units 20, 21, 22, 23, and 24 into a region in which the developing roller 42 and the supply roller 43 face each other. When a contact developing technique is used, the developing rollers 42 are in contact with the first and second photosensitive drums 10, 11, 12, 13, and 14. A developing bias voltage, which is used to supply the color toners accommodated in each of the first and second developing units 20, 21, 22, 23, and 24 to electrostatic latent images of the first and second photosensitive drums 10, 11, 12, 13, and 14, is applied to each of the developing rollers 42. Due to the developing bias voltage, an electric potential difference between the developing rollers 42 and the electrostatic latent images is produced so that the toners are detached from the surface of the developing rollers 42 and are attached to the electrostatic latent images and the electrostatic latent images are developed with the toners. When a non-contact developing technique is used, each of the developing rollers 42 is positioned to maintain a developing gap between each of the first and second photosensitive drums 10, 11, 12, 13, and 14, and for example, a bias voltage in which an AC current and a DC current are mixed, may be used as a developing bias voltage. The case where the contact developing technique is used will now be described.

An intermediate transfer belt 60 is an example of an intermediate transfer medium to which toner images developed on the first and second photosensitive drums 10, 11, 12, 13, and 14 are temporarily transferred. The intermediate transfer belt 60 faces the first and second photosensitive drums 10, 11, 12, 13, and 14, is supported by support rollers 61 and 62 and travels in a circle. A first transfer roller 70 faces the first photosensitive drum 10 in the state where the intermediate transfer belt 60 is placed therebetween. Each of second transfer rollers 71, 72, 73, and 74 faces each of the second photosensitive drums 11, 12, 13, and 14 in the state where the intermediate transfer belt 60 is placed therebetween. A first transfer bias voltage, which is used to attach the toner images developed on the first and second photosensitive drums 10, 11, 12, 13, and 14 to the intermediate transfer belt 60, is applied to each of the first and second transfer rollers 70, 71, 72, 73, and 74. For example, a conductive metal roller or a rubber roller in which a semi-conductive rubber having elasticity is put on a metal shaft may be used as each of the first and second transfer rollers 70, 71, 72, 73, and 74.

A final transfer roller 75 is positioned to face the intermediate transfer belt 60. A printing medium stacked on a paper feeding cassette 91 is carried by a carrying unit (not illustrated) between the final transfer roller 75 and the intermediate transfer belt 60. A second transfer bias voltage, which is used to transfer the toner images attached to the intermediate transfer belt 60 to the printing medium, is applied to the final transfer roller 75. A fusing unit 92 fuses the toner images on the printing medium by applying heat and pressure to the printing medium.

A cleaning blade 44 is an example of a cleaning unit which eliminates the toner remaining on the surface of each of the first and second photosensitive drums 10, 11, 12, 13, and 14 after an intermediate transfer operation.

Operation and effect by using the above-described structure will now be described.

When a printing instruction is input, image information is processed to image information about transparent (T), black (B), magenta (M), cyan (C), and yellow (Y) colors by a control unit (not illustrated). Image information about a transparent (T) color may be image information, which is used to develop a transparent toner image in a region which corresponds to a background portion of an image in which color toners such as black (B), magenta (M), cyan (C), and yellow (Y) are not attached. In order to make the gloss of the printed image uniform, image information about a transparent (T) color may be image information, which is used to develop a transparent toner image in a region in which the amount of attachment of color toners of black (B), magenta (M), cyan (C), and yellow (Y) is low and in a region which corresponds to the background portion of the image.

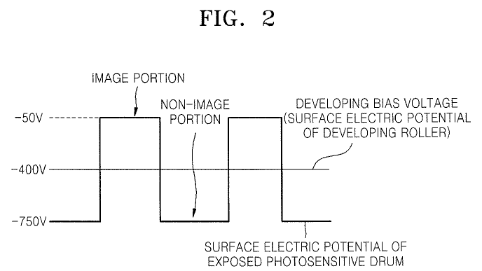

According to the image information about the transparent (T) color, the first exposing unit 30 scans light onto the first photosensitive drum 10 charged by the charging roller 41 to a uniform electric potential and thereby forms an electrostatic latent image. For example, the surface electric potential of the first photosensitive drum 10 charged by the charging roller 41 is approximately −750V, as illustrated in FIG. 2. The electric potential of an image portion onto which light is scanned by the first exposing unit 30 is approximately −50V. A non-image portion onto which light is not scanned is maintained at the surface electric potential of the charged first photosensitive drum 10. The average electric potential of the developing bias voltage to be applied to each developing roller 42 of the first developing unit 20 is approximately −400 V and is between the electric potential of the image portion and the electric potential of the non-image portion. Since the transparent toner is charged to a negative (−) polarity, when the developing bias voltage is applied to the developing roller 42, the transparent toner accommodated in the first developing unit 20 is attached to the image portion. A first transfer bias voltage having an opposite polarity to the charging polarity of the transparent toner is applied to the first transfer roller 70. As such, the transparent toner image developed on the first photosensitive drum 10 is transferred to the intermediate transfer belt 60. The transparent toner that remains on the first photosensitive drum 10 after a transfer operation is eliminated by the cleaning blade 44.

Next, according to the image information about the black (B) color, the second exposing unit 31 scans light onto the second photosensitive drum 11 charged by the charging roller 41 to a uniform electric potential and thereby forms an electrostatic latent image. For example, as illustrated in FIG. 2, the surface electric potential of the second photosensitive drum 11 charged by the charging roller 41 is approximately −750 V. The electric potential of an image portion in which light is scanned by the second exposing unit 31 is approximately −50 V. A non-image portion in which light is not scanned by the second exposing unit 31 is maintained to the electric potential of the surface of the charged second photosensitive drum 11 (i.e., approximately −750V). The average electric potential of the developing bias voltage to be applied to each developing roller 42 of the second developing unit 21 is between the electric potential of the image portion and the electric potential of the non-image portion. Since the black toner is charged to a negative (−) polarity, when the developing bias voltage is applied to the developing roller 42, the black toner accommodated in the first developing unit 21 is attached to the image portion. Afirst transfer bias voltage having an opposite polarity to the charging polarity of the black toner is applied to the second transfer roller 71. As such, the black toner image developed on the second photosensitive drum 11 is transferred to the intermediate transfer belt 60. The black toner that remains on the second photosensitive drum 11 after a transfer operation is eliminated by the cleaning blade 44.

The same operation as described above is performed by the second photosensitive drums 12, 13, and 14, the second exposing units 32, 33, and 34, and the second developing units 22, 23, and 24, respectively, at time intervals each of which is given by the formula (distance between photosensitive drums)/(carrying speed of intermediate transfer belt), so as to meet color registration requirements.

Through the above-described operations, toner images of black (B), magenta (M), cyan (C), yellow (Y), and transparent (T) are sequentially stacked on the intermediate transfer belt 60. At a time in which the color toner images reach a region in which the final transfer roller 75 and the intermediate transfer belt 60 face each other, the printing medium supplied from the paper feeding cassette 91 reaches the region. A second transfer bias voltage having an opposite polarity to the charging polarities of the transparent toner image and the color toner images are applied to the final transfer roller 75. Then, the toner images are transferred to the printing medium. When the printing medium passes the fusing unit 92, the color toner images are fused on the printing medium by heat and pressure and a printing operation is ended. Since the toners that are not transferred to the printing medium and remain on the intermediate transfer belt 60 are eliminated by a cleaning member 93, the toners are not mixed in the first and second developing units 20, 21, 22, 23, and 24 through the first and second photosensitive drums 10, 11, 12, 13, and 14.

A difference in gloss between the region in which the black (B), magenta (M), cyan (C), and yellow (Y) toner images are attached and the background region can be reduced through the above-described operations so that the quality of the printed image can be improved.

As described above, the color toners are accommodated in a toner-accommodating unit 46 disposed in each of the second developing units 21, 22, 23, and 24. Each of the second developing units 21, 22, 23, and 24 is replaced with a new one when all of the color toners accommodated therein are consumed. The amount of a consumed transparent toner in an image forming procedure is much larger than the amount of consumed color toners of black (B), magenta (M), cyan (C), and yellow (Y). Considering the coverage when a character image is printed is approximately 5%, the color toners are attached to an approximately 5% region of the printing medium and the transparent toner is attached to an approximately 95% region of the printing medium. Here, the coverage is the ratio of the area of an image portion (the area to which the toner is attached) to a printed area (for example, the area of the printing medium). In this consideration, when the transparent toner accommodated only in toner-accommodating unit 46 is disposed in the first developing unit 20, a period for replacing the first developing unit 20 is much shorter than a period for replacing the second developing units 21, 22, 23, and 24. In order to solve such a problem, the transparent toner is accommodated in an additional replaceable transparent toner container 80 and is supplied to the first developing unit 20. When the transparent toner accommodated in the transparent toner container 80 is consumed, the transparent toner container 80 is replaced with a new transparent toner container 80. Thus, the transparent toner having a large consumed amount can be smoothly supplied to the first developing unit 20 and a period for replacing the first developing unit 20 and a period for replacing each of the second developing units 21, 22, 23, and 24 can coincide with each other so that the developing ratio of the color toners and the transparent toner can be made uniform and an image of uniform quality can be printed. The features of the general inventive concept is not to exclude a structure in which the toner-accommodating unit 46 is disposed in the first developing unit 20 like in each of the second developing units 21, 22, 23, and 24. When the toner-accommodating unit 46 is disposed in the first developing unit 20, the transparent toner can be supplied to the toner-accommodating unit 46 from the transparent toner container 80.

The life span of a component such as the developing roller 42 of the first and second developing units 20, 21, 22, 23, and 24 is longer than a life span (maximum printable number) of the developing units 20, 21, 22, 23, and 24 that is calculated by the amount of the toner accommodated only in the toner-accommodating unit 46. In other words, the life span of components in the developing units 20, 21, 22, 23 and 24 generally outlive the remaining toner contained therein. In this consideration, replaceable color toner containers 81, 82, 83, and 84 to supply color toners to the second developing units 21, 22, 23, and 24 may be further provided, as indicated by a dotted line of FIG. 1. In this case, in order to coincide a period for replacing the transparent toner container 80 and a period for replacing the color toner containers 81, 82, 83, and 84 with each other, the toner-accommodating capacity of the transparent toner container 80 may be larger than the toner-accommodating capacity of the color toner containers 81, 82, 83, and 84. As indicated by a dotted line of FIG. 1, a transparent toner container 80a may be further provided so that the number of transparent toner containers can be larger than the number of color toner containers.

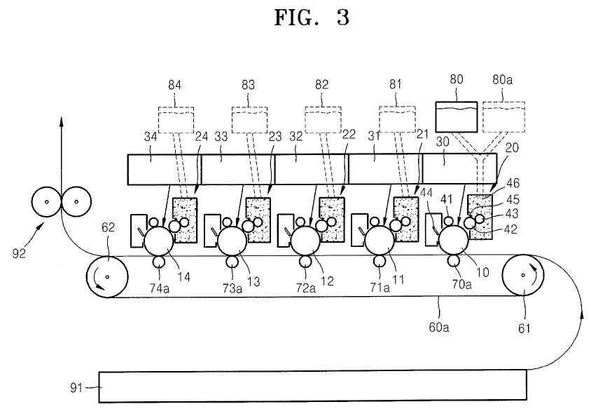

The above-described features may also be applied to a single pass image forming apparatus employing a direct transfer technique in which the toner image is directly transferred to the printing medium without an intermediate transfer operation, as illustrated in FIG. 3. Referring to FIG. 3, the printing medium withdrawn from the paper feeding cassette 91 is carried by a carrying belt 60a. Each of the transfer rollers 70a, 71a, 72a, 73a, and 74a faces each of the first and second photosensitive drums 10, 11, 12, 13, 14, and 15 in the state where the printing medium and the carrying belt 60a are placed therebetween. Through the above-described configuration, the transparent toner image and the color toner images respectively developed on the first and second photosensitive drums 10, 11, 12, 13, 14, and 15 are directly transferred to the printing medium by a transfer bias voltage applied to each of the transfer rollers 70a, 71a, 72a, 73a, and 74a.

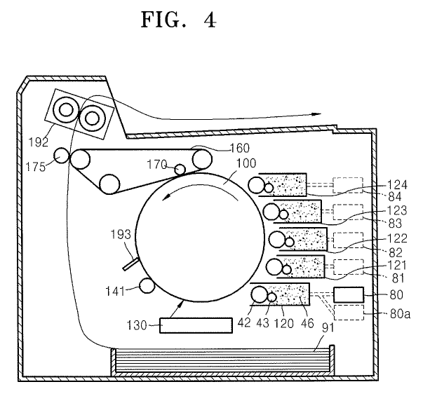

The above-described features may also be applied to a multiple pass image forming apparatus. FIG. 4 illustrates an electrophotographic image forming apparatus according to another embodiment. The electrophotographic image forming apparatus according to the embodiment of FIG. 4 is a multiple pass image forming apparatus which comprises a photosensitive drum 100, an exposing unit 130, a first developing unit 120 to develop a transparent toner image, and four second developing units 121, 122, 123, and 124 to develop color toner images. Referring to FIG. 4, the first and second developing units 120, 121, 122, 123, and 124 are disposed around the photosensitive drum 100. Atransparent toner is accommodated in a transparent toner container 80 and is supplied to the first developing unit 120. A toner-accommodating unit 46 in which color toners such as black (B), magenta (M), cyan (C), and yellow (Y) are accommodated is disposed in each of the second developing units 121, 122, 123, and 124.

The exposing unit 130 scans light onto the photosensitive drum 100 charged by a charging roller 141 to a uniform electric potential, firstly, according to black (B) image information, for example, and thereby forms an electrostatic latent image corresponding to black (B) on the surface of the photosensitive drum 100. When the black (B) toner is supplied to the electrostatic latent image by the second developing unit 121, a black toner image is formed on the surface of the photosensitive drum 100. The black toner image is transferred onto the intermediate transfer belt 160 by the first bias voltage applied to the intermediate transfer roller 170. The cleaning member 193 eliminates a black toner that remains on the photosensitive drum 100 after a transfer operation. When the black toner image which corresponds to a sheet of paper is transferred onto the intermediate transfer belt 100, toner images of magenta (M), cyan (C), and yellow (Y) colors are sequentially transferred onto the intermediate transfer belt 160 through the same operation.

Next, the exposing unit 130 scans light onto the photosensitive drum 100 charged by a charging roller 141 to a uniform electric potential according to transparent (T) image information, for example, and thereby forms an electrostatic latent image corresponding to transparent (T) on the surface of the photosensitive drum 100. A transparent toner image is formed on the surface of the photosensitive drum 100 by the transparent toner supplied by the first developing unit 120. The transparent toner image is transferred onto the intermediate transfer belt 160 by the first bias voltage applied to the intermediate transfer roller 170. As such, color toner images are formed on the intermediate transfer belt 160. The color toner images are transferred to the printing medium using a final transfer roller 175 and are fused using a fusing unit 912 so that color images having improved gloss can be printed. The features of above embodiments improve the utilization efficiency of the transparent toner. Thus, the scope of the embodiments is not limited by the above-described developing sequence of black (B), magenta (M), cyan (C), yellow (Y), and transparent (T) toners.

The first and second developing units 120, 121, 122, 123, and 124 may use one of a contact developing technique in which the developing roller 42 and the photosensitive drum 100 contact each other, a non-contact developing technique in which the developing roller 42 and the photosensitive drum 100 are separated from each other by a developing gap or a two-component developing technique. When a contact developing technique developing unit is employed as each of the first and second developing units 120, 121, 122, 123, and 124, each of the first and second developing units 120, 121, 122, 123, and 124 may be positioned in a developing location in which the developing roller 42 is in contact with the photosensitive drum 100 while performing a developing operation, and each of the first and second developing units 120, 121, 122, 123, and 124 may move to a stoppage location in which the developing roller 42 is separated from the photosensitive drum 100 while not performing a developing operation. Even when a non-contact developing technique is used, each of the first and second developing units 120, 121, 122, 123, and 124 may be positioned in a developing location in which the developing roller 42 is separated from the photosensitive drum 100 by a predetermined developing gap while performing a developing operation and may move to a stoppage location in which the developing roller 45 is separated from the photosensitive drum 100 by a large gap a distance while not performing a developing operation.

In addition, as indicated by a dotted line of FIG. 4, replaceable color toner containers 81, 82, 83, and 84 to supply color toners to the second developing units 121, 122, 123, and 124 may be further provided. In this case, the toner-accommodating capacity of the transparent toner container 80 may be larger than the toner-accommodating capacity of the color toner containers 81, 82, 83, and 84. As indicated by a dotted line of FIG. 4, a transparent toner container 80a may be further provided so that the number of transparent toner containers can be larger than the number of a color toner containers.

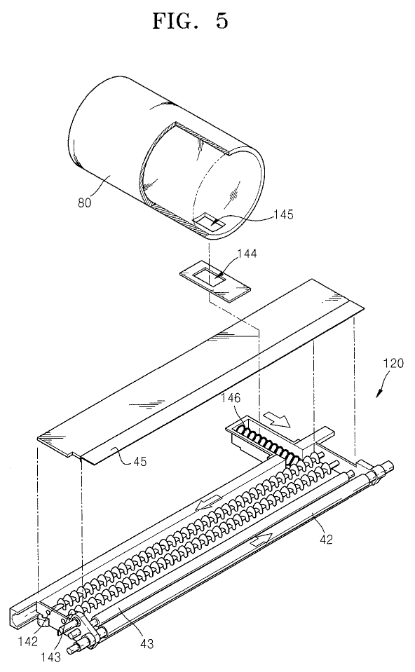

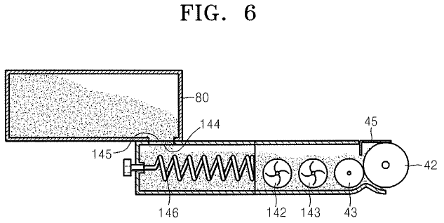

FIGS. 5 and 6 illustrate a perspective view and a cross-sectional view of an example of a structure to connect the first developing unit 120 and the transparent toner container 80, respectively. Referring to FIGS. 5 and 6, an inflow hole 144 connected to the transparent toner container 80 is disposed in the first developing unit 120. First and second augers 142 and 143 are an example of a conveying unit to convey the transparent toner supplied from the transparent toner container 80 toward the developing roller 42 and the supply roller 43. Although not illustrated, a shutter to close a supply hole 145 connected to the inflow hole 144 when the transparent toner container 80 is separated from the image forming apparatus and to open the supply hole 145 when the transparent toner container 80 is installed in the image forming apparatus may be further provided in the transparent toner container 80. In addition, a conveying unit 146 to convey the toner supplied from the transparent toner container 80 into the first developing unit 120 may be further disposed in the first developing unit 120. A spiral coil may be used as the conveying unit 146. Various devices such as an auger and a conveying belt (not illustrated) may be used as the conveying unit 146. However, the price of the spiral coil is lower than the price of the auger or conveying belt and the cross-section of the spiral or turns of the spiral is adjusted so that a conveying capacity can be easily controlled. Through the above-described configuration, when the transparent toner is consumed, the transparent toner container 80 has only to be replaced with a new one. The first developing unit 120 has only to be replaced when its life span is expired, and therefore is not dependent on an amount of toner therein. The structure to connect the second developing units 121, 122, 123, and 124 and the color toner containers 81, 82, 83, and 84 may also be the same as the structure illustrated in FIG. 5. In addition, the structure to connect the first developing unit 120 and the transparent toner container 80 illustrated in FIGS. 5 and 6 may also be applied to the single pass color image forming apparatus illustrated in FIGS. 1 and 3.

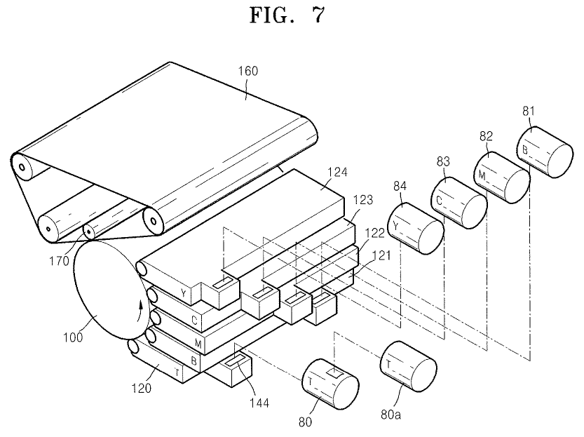

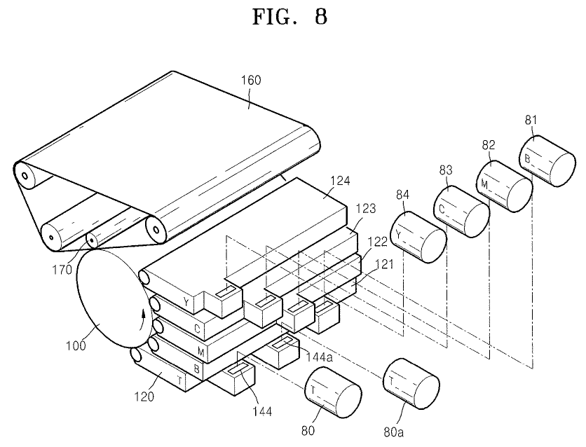

When two or more transparent toner containers 80 and 80a are provided, the transparent toner containers 80 and 80a may be connected to each other, as illustrated in FIG. 7. In addition, two inflow holes 144 and 144a may be disposed in the first developing unit 120, and the transparent toner containers 80 and 80a may also be connected to the inflow holes 144 and 144a, respectively, as illustrated in FIG. 8.

As described above, in the electrophotographic image forming apparatus according to the various embodiments, a transparent toner having a large consumed amount can be smoothly supplied. In addition, a period to replace a developing unit of a transparent toner and a period for replacing a developing unit of a color toner can coincide with each other such that the developing ratio of the color toners and the transparent toner is made uniform and an image of uniform quality is printed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic image forming apparatus comprising:
a photosensitive body;
an exposing unit to form an electrostatic latent image on the photosensitive body charged to a uniform electric potential;
a first developing unit to develop the electrostatic latent image on the photosensitive body by supplying a transparent toner thereto;
a transparent toner container in which the transparent toner to be supplied to the first developing unit is accommodated; and
a second developing unit to develop the electrostatic latent image on the photosensitive body by supplying color toners thereto and having a toner-accommodating unit in which the color toners are accommodated.

2. The apparatus of claim 1, wherein color images are printed using a multiple pass technique by comprising:
a plurality of the second developing units to develop the electrostatic latent image on the photosensitive body by supplying different color toners thereto; and
a transfer medium to which a plurality of color toner images and a transparent toner image sequentially formed on the photosensitive body are sequentially transferred.

3. The apparatus of claim 1, wherein
the photosensitive body comprises:
a first photosensitive body corresponding to the first developing unit, and a second photosensitive body corresponding to the second developing unit; and
wherein the exposing unit comprises:
a first exposing unit corresponding to the first photosensitive body, and
a second exposing unit corresponding to the second photosensitive body.

4. The apparatus of claim 3, wherein color images are printed using a single pass technique by comprising:
a plurality of the second photosensitive bodies;
a plurality of the second exposing units to form electrostatic latent images on the plurality of the second photosensitive bodies; and
a plurality of the second developing units to develop the electrostatic latent images of the plurality of the second photosensitive bodies by supplying different color toners thereto.

5. The apparatus of claim 1, wherein a life span of the transparent toner container is shorter than life spans of the first and second developing units.

6. An electrophotographic image forming apparatus comprising:
a photosensitive body;
an exposing unit to form an electrostatic latent image on the photosensitive body charged to a uniform electric potential;
a first developing unit to develop the electrostatic latent image on the photosensitive body by supplying a transparent toner thereto;
a second developing unit to develop the electrostatic latent image on the photosensitive body by supplying color toners thereto;
a transparent toner container in which the transparent toner to be supplied to the first developing unit is accommodated; and
a color toner container in which the color toners to be supplied to the second developing unit are accommodated,
wherein the number of the transparent toner containers is larger than the number of the color toner containers.

7. The apparatus of claim 6, wherein life spans of the transparent toner container and the color toner container are shorter than life spans of the first and second developing units.

8. The apparatus of claim 7, wherein color images are printed using a multiple pass technique by comprising:
a plurality of the second developing units and a plurality of the color toner containers to develop the electrostatic latent image on the photosensitive body by supplying different color toners thereto; and
a transfer medium to which a plurality of color toner images and a transparent toner image sequentially formed on the photosensitive body are sequentially transferred.

9. The apparatus of claim 7,
wherein the photosensitive body comprises:
a first photosensitive body corresponding to the first developing unit, and
a second photosensitive body corresponding to the second developing unit; and
wherein the exposing unit comprises:
a first exposing unit corresponding to the first photosensitive body, and
a second exposing unit corresponding to the second photosensitive body.

10. The apparatus of claim 9, wherein color images are printed using a single pass technique by comprising:
a plurality of the second photosensitive bodies;
a plurality of the second exposing units to form electrostatic latent images on the plurality of the second photosensitive bodies;
a plurality of the second developing units and a plurality of the color toner containers to develop the electrostatic latent images of the plurality of the second photosensitive bodies by supplying different color toners thereto.

11. An electrophotographic image forming apparatus comprising:
a photosensitive body;
an exposing unit to form an electrostatic latent image on the photosensitive body charged to a uniform electric potential;
a first developing unit to develop the electrostatic latent image on the photosensitive body by supplying a transparent toner thereto;
a second developing unit to develop the electrostatic latent image on the photosensitive body by supplying color toners thereto;
a transparent toner container in which the transparent toner to be supplied to the first developing unit is accommodated; and
a color toner container in which the color toners to be supplied to the second developing unit are accommodated,
wherein a capacity of the transparent toner container is larger than a capacity of the color toner container.

12. The apparatus of claim 11, wherein life spans of the transparent toner container and the color toner container are shorter than life spans of the first and second developing units.

13. The apparatus of claim 12, wherein color images are printed using a multiple pass technique by comprising:
a plurality of the second developing units and a plurality of the color toner containers to develop the electrostatic latent image on the photosensitive body by supplying different color toners thereto; and
a transfer medium to which a plurality of color toner images and a transparent toner image sequentially formed on the photosensitive body are sequentially transferred.

14. The apparatus of claim 12,
wherein the photosensitive body comprises:
a first photosensitive body corresponding to the first developing unit; and
a second photosensitive body corresponding to the second developing unit, and
wherein the exposing unit comprises:
a first exposing unit corresponding to the first photosensitive body; and
a second exposing unit corresponding to the second photosensitive body.

15. The apparatus of claim 14, wherein color images are printed using a single pass technique by comprising:
a plurality of the second photosensitive bodies;
a plurality of the second exposing units to form electrostatic latent images on the plurality of the second photosensitive bodies;
a plurality of the second developing units and a plurality of the color toner containers to develop the electrostatic latent images of the plurality of the second photosensitive bodies by supplying different color toners thereto.

16. An electrophotographic image forming apparatus comprising:
a first photosensitive body to carry a transparent toner image using an electrostatic potential;
at least one second photosensitive body to carry a respective color image using an electrostatic potential;
a first developing unit to accommodate transparent toner and to develop the transparent image onto the first photosensitive body;
at least one second developing unit to accommodate a respective color toner and to develop a respective color toner image onto the second photosensitive body; and
at least one replaceable transparent toner container to accommodate additional transparent toner and to supply the additional transparent toner to the first developing unit.

17. The electrophotographic image forming apparatus of claim 16,
wherein each of the at least one second developing unit comprise a toner accommodating unit to accommodate the respective color toner, and
wherein the toner accommodating capacity of the replaceable transparent toner container is larger than the toner accommodating capacity of the toner accommodating units.

18. The electrophotographic image forming apparatus of claim 17, further comprising:
at least one replaceable color toner container to accommodate a respective additional color toner and to supply the additional color toner to a toner accommodating unit of the respective at least one second developing unit.

19. The electrophotographic image forming apparatus of claim 18, wherein the toner-accommodating capacity of the transparent toner container is larger than the toner-accommodating capacity of the replaceable color toner containers.

20. The electrophotographic image forming apparatus of claim 16, wherein the at least one replaceable transparent toner container comprises two replaceable transparent toner containers each connected to the first developing unit.
